(19) United States
(12) Patent Application Publication
(10) Pub. No.: US 2020/0114932 A1
(43) Pub. Date: Apr. 16, 2020

(54) VEHICLE AND METHOD OF OUTPUTTING INFORMATION THEREFOR

(71) Applicants: HYUNDAI MOTOR COMPANY, Seoul (KR); KIA MOTORS CORPORATION, Seoul (KR)

(72) Inventors: Jeong Won LEE, Suwon-si (KR); Ju Won KIM, Anyang-si (KR); Joon Young KIM, Seongnam-si (KR); Dong Uk KIM, Incheon (KR)

(21) Appl. No.: 16/205,957

(22) Filed: Nov. 30, 2018

(30) Foreign Application Priority Data
Oct. 12, 2018 (KR) 10-2018-0121978

(51) Int. Cl. B60W 50/14; B60K 35/00; B60W 50/10; G06K 9/00

(52) U.S. Cl. CPC B60W 50/14; B60W 2540/26; B60W 50/10; G06K 9/00825; G06K 9/00838; G06K 9/00845; B60K 2350/1096; B60W 2050/146; B60K 2350/1052; B60K 2350/1024; B60K 2350/102; B60W 2550/12; B60W 2550/14; B60W 2550/22; B60K 35/00

(57) ABSTRACT

A vehicle capable of outputting information to an occupant therein using variable priority order and a method for performing the same are provided. A method of outputting information of a vehicle may include: recognizing a current situation on the basis of at least one piece of input information; determining a function to which a weight is applied in the recognized situation among a plurality of functions of the vehicle; resetting priority orders for the plurality of functions of the vehicle on the basis of the determined function to which a weight is applied; and determining whether output information about each of at least one event is output on the basis of the reset priority orders.

This application claims the benefit of Korean Patent Application No. 10-2018-0121978, filed on Oct. 12, 2018 in the Korean Intellectual Property Office, which is hereby incorporated by reference as if fully set forth herein.

### TECHNICAL FIELD

The present disclosure relates to a vehicle capable of outputting information to an occupant therein using variable priority order and a method for performing the same.

### BACKGROUND

Contemporary vehicles are equipped with various electronic apparatuses and provide various types of information to occupants through an infotainment system such as an AVN (Audio/Video/Navigation) system as connectivity performance thereof is improved.

However, when two or more pieces of information need to be simultaneously output in a general vehicle, information with a high priority order is output first or alone according to priority orders predetermined for respective functions, in general.

Accordingly, if information on a specific function is important for an occupant/vehicle state or a driving situation but is not reflected in priority orders predetermined for respective functions, the information cannot be provided to an occupant at a proper time.

### SUMMARY

Accordingly, the present disclosure is directed to a method for changing information output priority order per function according to circumstances and a vehicle capable of performing the same.

It will be appreciated by persons skilled in the art that the objects that could be achieved with the present disclosure are not limited to what has been particularly described hereinabove and the above and other objects that the present disclosure could achieve will be more clearly understood from the following detailed description.

To achieve the objects and other advantages and in accordance with the purpose of the disclosure, as embodied and broadly described herein, a method of outputting information of a vehicle according to an embodiment of the present disclosure may include: recognizing a current situation on the basis of at least one piece of input information; determining a function to which a weight is applied in the recognized situation among a plurality of functions of the vehicle; resetting priority orders for the plurality of functions of the vehicle on the basis of the determined function to which a weight is applied; and determining whether output information about each of at least one event is output on the basis of the reset priority orders.

In addition, a vehicle according to an embodiment of the present disclosure may include: a situation recognition device configured to recognize a current situation on the basis of at least one piece of input information; a priority determination device configured to determine a function to which a weight is applied in the recognized situation among a plurality of functions of the vehicle and to reset priority orders for the plurality of functions of the vehicle on the basis of the determined function to which a weight is applied; and an output controller configured to determine whether output information about each of at least one event is output on the basis of the reset priority orders.

The vehicle according to at least one embodiment of the present disclosure, configured as described above, can variably set information output priority order per function according to circumstances such that important information can be provided to an occupant at a time when the information is necessary.

It will be appreciated by persons skilled in the art that the effects that can be achieved with the present disclosure are not limited to what has been particularly described hereinabove and other advantages of the present disclosure will be more clearly understood from the following detailed description.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram illustrating an example of a vehicle configuration according to an embodiment of the present disclosure;

FIG. 2 illustrates an example of a process of determining priority order through circumstance recognition according to an embodiment of the present disclosure;

FIG. 3 is a flowchart illustrating an example of a process of providing output information per function according to circumstances in a vehicle according to an embodiment of the present disclosure;

FIG. 4 illustrates an example of a configuration of a priority table according to an embodiment of the present disclosure;

FIG. 5 is a view illustrating an example of an information output device constituting an output device included in the vehicle according to an embodiment of the present disclosure;

FIG. 6 is a flowchart illustrating an example of a process of displaying output information according to interactive display state according to an embodiment of the present disclosure; and

FIG. 7 illustrates an example of a configuration of a priority table according to interactive display states.

### DETAILED DESCRIPTION

Embodiments of the present disclosure will be described in detail with reference to the accompanying drawings so that the present disclosure can be easily realized by those skilled in the art. However, the present disclosure can be realized in various different forms and is not limited to the embodiments described herein. Parts that are not related to description will be omitted for clear description in the drawings, and the same reference numbers will be used throughout this specification to refer to the same or like parts.

Throughout the specification, the term “includes” should be interpreted not to exclude other elements but to further include such other elements since the corresponding elements may be included unless mentioned otherwise. Further, the same reference numbers will be used throughout this specification to refer to the same or like parts.

In an embodiment of the present disclosure, information output priority order per function is variably set according to vehicle situation.

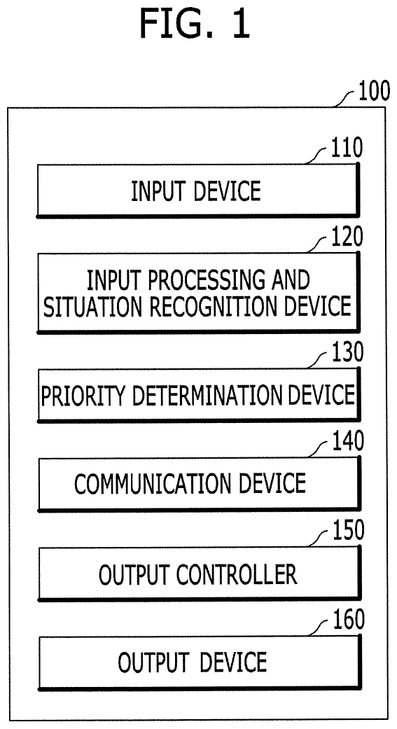

First, a vehicle structure to which embodiments of the present disclosure are applicable will be described with reference to FIG. 1. FIG. 1 is a block diagram showing an example of a vehicle structure according to an embodiment of the present disclosure.

Referring to FIG. 1, a vehicle according to the present embodiment includes an information output system 100. The information output system 100 may include an input device 110, an input processing and situation recognition device 120, a priority determination device 130, a communication device 140, an output controller 150 and an output device 160.

The input device 110 acquires information related to various events occurring inside/outside the vehicle, such as a vehicle state, a driver state and a driving environment. To this end, the input device may include a microscope through which sound inside of the vehicle is input, one or more cameras for photographing the inside and/or the outside of the vehicle, sensors and the like. Here, the sensors may include an ultrasonic/laser range sensor, a vision sensor, a seat weight detecting sensor, a touch sensor, a motion sensor, a rain sensor, an illumination sensor, a tire pressure sensor and the like, but these are exemplary and any sensor can be used if it can be mounted in the vehicle.

The input processing and situation recognition device 120 may recognize and determine the intention or state of a user, internal/external situations of the vehicle, a vehicle state, situations of remote places, and the like through various values (touch/motion/voice/sensor values/operation state values of controllers/information acquired from external servers through wireless communication) acquired through the input device 110 and the communication device 140.

The priority determination device 130 may determine whether default output information priority order per function (hereinafter referred to as “default priority order”) is applied or adjusted according to a current situation determined by the input processing and situation recognition device 120. For example, output information priority order per function can be determined according to the default priority order when a function to which a weight is applied is not present in the determined current situation, whereas priority order can be adjusted such that the priority order of a function to which a weight is applied is increased when the function is present in the determined current situation.

The communication device 140 may perform communication with various vehicle controllers (cluster, air-conditioner, seats, and the like) in the vehicle and external servers. To this end, the communication device 140 may include a wired communication module for supporting wired communication protocols such as CAN, CAN-FD, LIN and Ethernet and a wireless communication module for supporting cellular wireless communication protocols such as 3G/4G/5G and short-range wireless communication protocols such as Wi-Fi, Bluetooth, ZigBee and NFC.

The output controller 150 may control devices constituting the output device 160 to provide feedback according to information output per function to be output depending on priority order determined by the priority determination device 130.

The output device 160 may output at least one of visual/auditory/haptic outputs through output devices such as a display/LED/motor/speaker in the system under the control of the output controller 150.

Hereinafter, embodiments of the present disclosure will be described on the basis of the above-described vehicle structure.

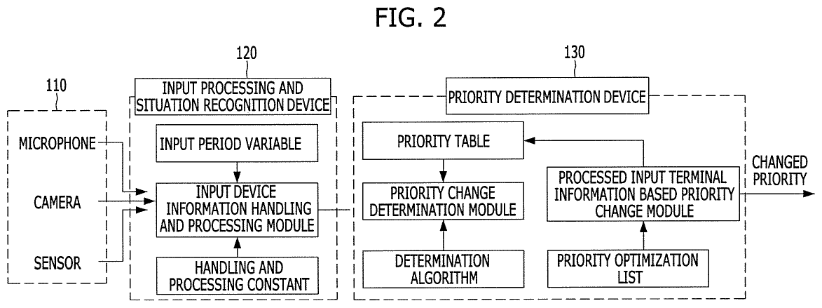

FIG. 2 shows an example of a process of determining priority order through situation recognition according to an embodiment of the present disclosure.

Referring to FIG. 2, an input device information handling and processing module of the input processing and situation recognition device 120 may extract a circumstance feature or index by handling and processing each piece of input data information on the basis of information acquired through the input device 110 including a microscope, a camera, and sensors. Here, the input device information handling and processing module uses an input period variable and a constant for handling and processing. Here, the input period variable refers to a period of input terminal request information for preventing frequency change and may be set to a value increasing as it becomes short.

A priority change determination module of the priority determination device 130 may determine whether priority order needs to be changed on the basis of feature/index information received from the input processing and situation recognition device 120. Here, the priority change determination module may determine whether priority order needs to be changed with reference to a priority table according to a predetermined determination algorithm. Here, the priority table may include information which defines operation priority order per behavior pattern and function of each device in the vehicle and update thereof in a predetermined order. In addition, a processed input terminal information based priority change module may change the priority table on the basis of the feature/index information. To this end, the processed input terminal information based priority change module may refer to a priority optimization list including priority optimization techniques.

When priority order per function is changed in the priority determination device 130, the output controller may determine whether output information per function is output with reference to the changed priority table.

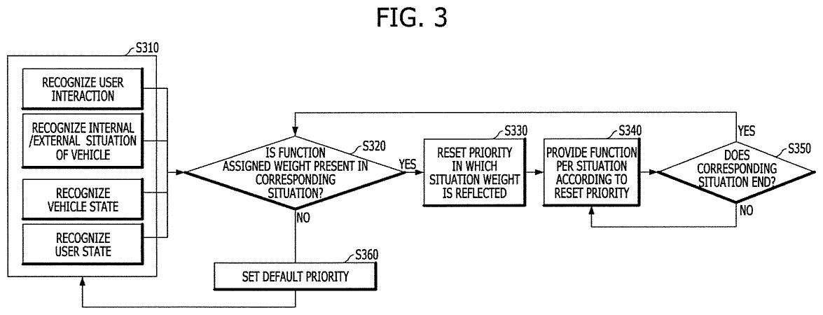

Hereinafter, a process of providing output information per function according to situation will be described with reference to FIG. 3. FIG. 3 is a flowchart illustrating an example of a process of providing output information per function according to situation in the vehicle according to an embodiment of the present disclosure.

Referring to FIG. 3, the input processing and situation recognition device 120 may perform situation recognition on the basis of information acquired through the input device 110 and the communication device 140 (S310). Situation recognition may be classified into recognition of user interaction, recognition of an internal/external situation of a vehicle, recognition of a vehicle state, and recognition of a user state, but this is exemplary and situation recognition may not be limited thereto. User interaction recognition may be a process of recognizing input of a command through a user operation such as a button/dial/touch operation or gesture of a user. Recognition of an internal/external situation of a vehicle may be a process of recognizing weather, presence or absence of an accident, a road surface state, presence or absence of an occupant in a front passenger seat or a back seat, traffic light change, tunnel information, and the like. Recognition of a vehicle state may be a process of recognizing vehicle trouble, the position of a gearshift or an operation system, a driving mode, and the like. Recognition of a user state may be a process of recognizing situations in which a driver does not keep eyes forward due to drowsiness, viewing a cellular phone, turning the head to the back seat, and the like, or a driver's emotion such as anger.

Through this recognition process S310, the input processing and situation recognition device 120 may generate feature/index information about the current situation and the priority determination device 130 may determine whether a function to which a weight is applied is present in the situation corresponding to the generated feature/index information (S320).

When the function to which a weight is applied is present in the corresponding situation, the priority determination device 130 may reset priority order by reflecting a situation weight therein (S330).

Upon resetting of priority order, the output controller 150 may check the priority order of an event in the changed priority table when the event is generated and determine whether to output output information according to the priority order (S340). For example, if only a single event is currently present, output information about the event can be output through the output device 160 irrespective of priority order. If two or more events are generated together, output information about an event with the highest priority order in the changed priority table can be output through the output device 160.

The priority determination device 130 may determine whether the corresponding situation ends (S350) and monitor whether a situation in which a function to which a weight is applied is present occurs again when the corresponding situation ends.

The priority determination device 130 may change the priority table to the default setting in situations in which a function to which a weight is applied is not present (S360).

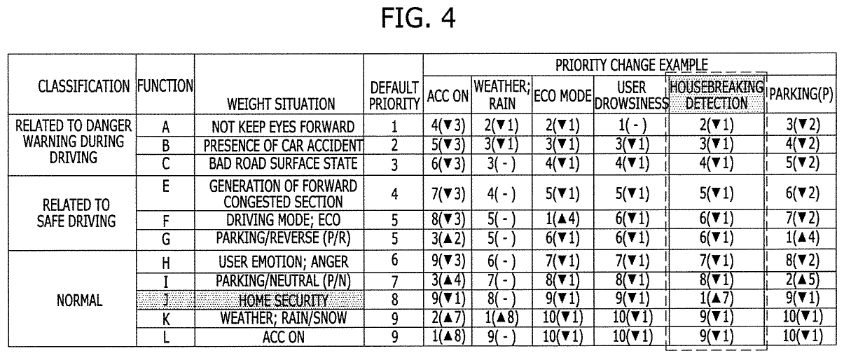

Hereinafter, a modified example according to formats of the aforementioned priority table and situations will be described with reference to FIG. 4. FIG. 4 shows an example of a priority table configuration according to an embodiment of the present disclosure.

Referring to FIG. 4, the priority table includes 11 functions of A to C and E to L which are classified into three types of “danger warning during driving”, “safety driving” and “normal”. Further, a weight situation and a default priority order according to default settings are defined per function in the priority table. In addition, a priority change per function when each weight situation occurs may also be defined in the priority table.

For example, on the assumption that function J in the normal category is a home security IoT device control related function, the default priority order of 8 is set in situations other than the corresponding weight situation. However, in the corresponding weight situation in which a danger of a house such as housebreaking is detected, the priority order is adjusted to 1. Accordingly, priority orders of other functions can decrease by one step.

When this process is applied to FIG. 3, if a housebreaking detection situation is recognized as an internal/external situation of the vehicle on the basis of information on an operation state of a home IoT device in step S310, function J is determined to be a function to which a weight is applied in the corresponding situation in step S320 and priority order is reset such that function J has the highest priority order in step 5330.

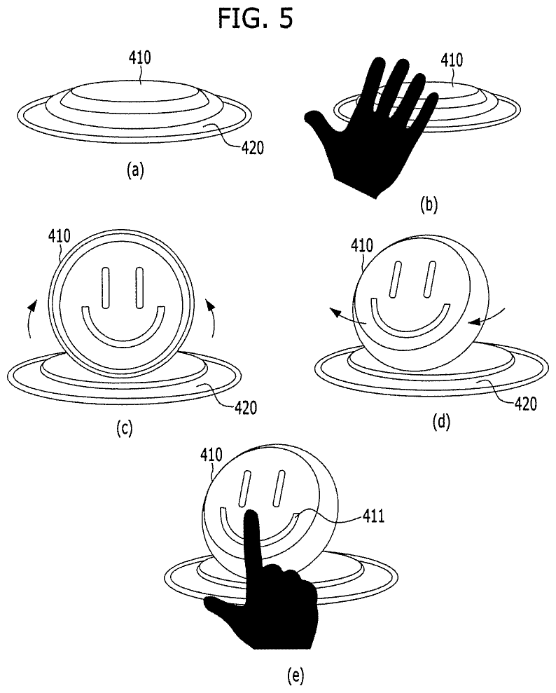

Next, priority changes due to user interaction associated with a specific device in the vehicle and a vehicle state will be described with reference to FIGS. 5 to 7.

FIG. 5 is a diagram for describing an example of an information output device constituting the output device included in the vehicle according to an embodiment of the present disclosure.

Referring to (a) in FIG. 5, an interactive display is illustrated as an example of the output device 160 applicable to embodiments of the present disclosure. The interactive display can support not only a function of transferring information to a user but also emotion replication according to an image displayed on a display 410 and a driver's gesture. The interactive display may be disposed on a disk-shaped base 420 and may include the disk-shaped display 410 having a smaller diameter than the base.

The display 410 is implemented as a circular touchscreen. The display 410 may be laid on the base 420 in an off or sleep state and may wake up as shown in (c) in FIG. 5 when a user makes a gesture of stroking the display 410 as shown in (b) in FIG. 5 or a driver getting in the vehicle is recognized. Here, the display 410 may be erected at a specific angle with respect to the base 420 according to wake-up and may display an image representing an expression corresponding to the current situation of the vehicle or the driver. In addition, the display 410 may be rotated about one axis of the base 420, as shown in (d) in FIG. 5. For example, the display 410 can be rotated to face in a direction in which the driver is positioned. In addition, when the user brings a finger to a mouth 411 displayed on the display 410, as shown in (e) in FIG. 5, the display may enter the sleep mode as shown in (a) in FIG. 5.

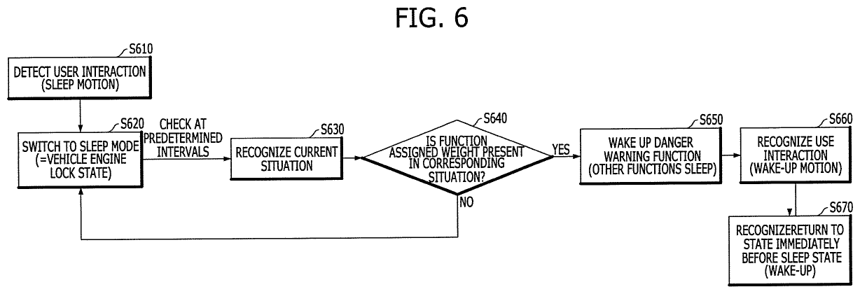

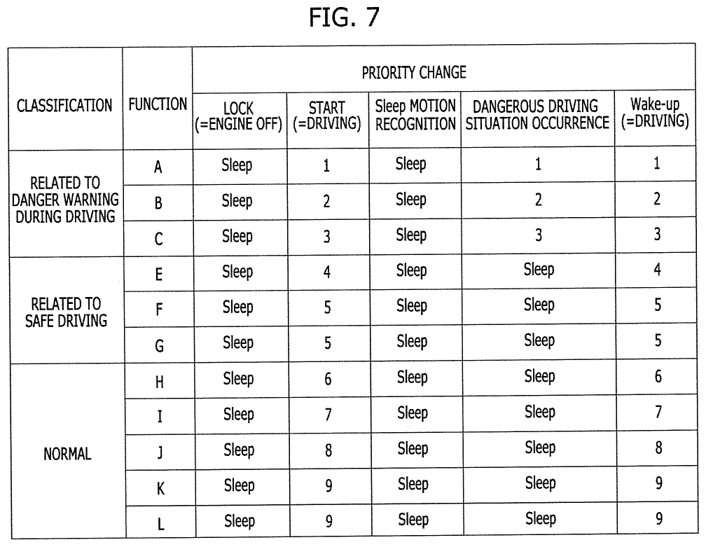

A process of changing priority order per function upon entering the sleep mode when the above-described interactive display is applied will be described with reference to FIGS. 6 and 7. Although description focuses on the interactive display in FIGS. 6 and 7, it should be understood that the function which will be described later can be applied to other input/output devices included in the vehicle in a similar manner.

FIG. 6 is a flowchart illustrating an example of a process of outputting output information according to state of the interactive display according to an embodiment of the present disclosure and FIG. 7 illustrates an example of a priority table configuration according to state of the interactive display.

Referring to FIG. 6, when a gesture/motion corresponding to a sleep command is input to the interactive display, as shown in (e) in FIG. 5 (S610), the interactive display may enter the sleep mode (S620).

In this state, the input processing and situation recognition device 120 may determine a situation at time intervals according to the input period variable and recognize the current situation according thereto (S630). Through this recognition process 5630, the input processing and situation recognition device 120 may generate feature/index information about the current situation and the priority determination device 130 may determine whether a function to which a weight is applied is present in the situation corresponding to the generated feature/index information (S640).

When the function of assigning a weight is present in the corresponding situation, the priority determination device 130 may reset priority order by reflecting a situation weight therein. Here, the priority determination device 130 may further consider the state of the output device 160. For example, when the interactive display is in a sleep state according to user interaction, priority order according to the sleep state can be applied. For example, priority order per function with respect to the interactive display corresponds to a sleep state (i.e., a state in which output information is not output) upon entering an engine off state and a sleep state due to a sleep motion, as shown in FIG. 7. However, when a dangerous driving situation is recognized in the sleep state, priority orders of functions A/B/C to which a weight is applied in the corresponding situation are not processed into a sleep state but are set to predetermined priority orders.

Accordingly, the output controller 150 may wake up the interactive display when there is a function which requires output information output in the reset priority order (S650). Accordingly, even when the interactive display enters the sleep state according to sleep gesture input of the user, the interactive display can wake up in a specific situation and present output information of a function related to the situation. Of course, the sleep state may be maintained for functions irrelevant to output information.

Referring back to FIG. 6, when user interaction for waking up the interactive display is detected (S660), the interactive display can wake up irrespective of output information (S670).

Therefore, according to embodiments of the present disclosure, it is possible to variably set priority orders of functions according to situations and provide important information per situation to a user at a proper time. In addition, it is possible to variably set priority order according to situations and events instead of changing priority order according to setting of normal default priority order or a manual, which is convenient. Furthermore, priority order can be separately managed per output device, as described above with reference to FIGS. 5 to 7, and thus priority order per situation can be variably set for various output devices.

The various embodiments disclosed herein, including embodiments of the information output system 100 and/or the elements thereof including, but not limited to, the input processing and situation recognition device 120, the priority determination device 130, the output controller 150, can be implemented using one or more processors coupled to a memory (or other non-transitory computer readable recording medium) storing computer-executable instructions and/or algorithm for causing the processor(s) to perform the operations and/or functions described above. The present disclosure may be implemented as code readable by a computer and stored in a non-transitory, or transitory, computer-readable recording medium. The computer-readable recording medium includes all kinds of recording devices in which data readable and executable by computer systems and/or processors to perform the above described operations and/or functions is stored. Examples of the computer-readable recording medium include an HDD (Hard Disk Drive), an SSD (Solid State Drive), an SDD (Silicon Disk Drive), a ROM, a RAM, a CD-ROM, a magnetic tape, a floppy disk, an optical data storage device, and the like.

Accordingly, the above description needs to be construed in all aspects as illustrative and not restrictive. The scope of the present disclosure should be determined by the appended claims and their legal equivalents, not by the above description, and all changes coming within the meaning and equivalency range of the appended claims are intended to be embraced therein.

What is claimed is:

1. A method of outputting information of a vehicle, comprising:
recognizing a current situation on the basis of at least one piece of input information;
determining a function to which a weight is applied in the recognized situation among a plurality of functions of the vehicle;
resetting priority orders for the plurality of functions of the vehicle on the basis of the determined function to which a weight is applied; and
determining whether output information about each of at least one event is output on the basis of the reset priority orders.

2. The method according to claim 1, wherein the recognizing comprises acquiring the at least one piece of input information input from an input device according to a request period variable.

3. The method according to claim 1, further comprising determining whether output information about each of at least one event is output on the basis of default priority orders for the plurality of functions of the vehicle when there is no function to which a weight is applied.

4. The method according to claim 1, wherein the resetting is performed with reference to a priority table in which priority orders for a plurality of situations and the plurality of functions of the vehicle are defined.

5. The method according to claim 1, wherein the recognizing of the current situation comprises at least one of:
recognizing user interaction;
recognizing an internal/external situation of the vehicle;
recognizing a vehicle state; and
recognizing a user state.

6. The method according to claim 5, wherein the recognizing of user interaction comprises recognizing at least one of a button operation, a dial operation, a touch operation, and a gesture of a user.

7. The method according to claim 5, wherein the recognizing of an internal/external situation of the vehicle comprises recognizing at least one of weather, presence or absence of an accident, a road surface state, presence or absence of an occupant in a front passenger seat or a back seat, traffic light change, and tunnel information.

8. The method according to claim 5, wherein the recognizing of a vehicle state comprises recognizing at least one of vehicle trouble, a position of a gearshift, a position of an operation system, and a driving mode, and
the recognizing of a user state comprises recognizing at least one of drowsiness, viewing a cellular phone and turning the head to the back seat of a driver, and an emotion of the driver.

9. The method according to claim 1, further comprising determining a state of a specific output device among output devices for outputting the output information,
wherein the resetting of the priority orders is performed in further consideration of the state of the specific output device.

10. A non-transitory computer-readable recording medium storing a program that, when executed by a computer, causes the computer to perform the method of outputting information of a vehicle according to claim 1.

11. A vehicle comprising:
a situation recognition device configured to recognize a current situation on the basis of at least one piece of input information;
a priority determination device configured to determine a function to which a weight is applied in the recognized situation among a plurality of functions of the vehicle and to reset priority orders for the plurality of functions of the vehicle on the basis of the determined function to which a weight is applied; and
an output controller configured to determine whether output information about each of at least one event is output on the basis of the reset priority orders.

12. The vehicle according to claim 11, wherein the situation recognition device acquires the at least one piece of input information input from an input device according to a request period variable.

13. The vehicle according to claim 11, wherein the output controller determines whether output information about each of at least one event is output on the basis of default priority orders for the plurality of functions of the vehicle when there is no function to which a weight is applied.

14. The vehicle according to claim 11, wherein the priority determination device performs resetting with reference to a priority table in which priority orders for a plurality of situations and the plurality of functions of the vehicle are defined.

15. The vehicle according to claim 11, wherein the situation recognition device recognizes at least one of user interaction, an internal/external situation of the vehicle, a vehicle state, and a user state.

16. The vehicle according to claim 15, wherein the user interaction includes at least one of a button operation, a dial operation, a touch operation, and a gesture of a user.

17. The vehicle according to claim 15, wherein the internal/external situation of the vehicle includes at least one of weather, presence or absence of an accident, a road surface state, presence or absence of an occupant in a front passenger seat or a back seat, traffic light change, and tunnel information.

18. The vehicle according to claim 15, wherein the vehicle state includes at least one of vehicle trouble, a position of a gearshift, a position of an operation system and a driving mode, and
the user state includes at least one of drowsiness, viewing a cellular phone and turning the head to the back seat of a driver, and an emotion of the driver.

19. The vehicle according to claim 11, further comprising an output device configured to output the output information,
wherein the priority determination device resets the priority orders in further consideration of the state of the output device.
